(19) United States
(12) Patent Application Publication
(10) Pub. No.: US 2022/0036554 A1
(43) Pub. Date: Feb. 3, 2022

(54) SYSTEM AND METHOD FOR SUPPORTING THE EMOTIONAL AND PHYSICAL HEALTH OF A USER

(71) Applicant: Healthcare Integrated Technologies Inc., Knoxville, TN (US)

(72) Inventors: Kenneth M. GREENWOOD, Davenport, FL (US); Scott Michael BORUFF, Knoxville, TN (US); Jurgen K. VOLLRATH, Sherwood, OR (US)

(21) Appl. No.: 17/390,712

(22) Filed: Jul. 30, 2021

Related U.S. Application Data
(60) Provisional application No. 63/103,413, filed on Aug. 3, 2020.

(51) Int. Cl. G06T 7/00; G10L 25/63; G10L 25/66; G06K 9/00

(52) U.S. Cl. CPC G06T 7/0014; G10L 25/63; G06T 2207/20081; G06K 9/00302; G06K 9/00335; G10L 25/66

(57) ABSTRACT

A method and system for improving the well-being of a user, comprises an artificial intelligence system coupled to a microphone and video camera for capturing verbal and visual input from the user, and a speaker for engaging the user in conversation to provide virtual companionship and to assess the user's physiological and emotional demeanor.

### FIELD OF THE INVENTION

The present invention relates to the support of elderly and disabled people. In particular it relates to a system and method for improving physical and mental well-being.

### BACKGROUND OF THE INVENTION

People in old age homes, care facilities, hospitals, or who are living alone are more likely to suffer from depression and feel separated from society. Often age or physical disabilities compound their seclusion due to their limited mobility. It is therefore vitally important to ensure their ability to communicate with others, both for their mental well-being as well as a way to notify someone in the case of an emergency.

Patients debilitated sufficiently to be unable to operate phone or mechanical equipment are particularly at risk. Therefore, having a way for relatives to talk to them unassisted would be extremely helpful especially in times of increased isolation e.g., during a pandemic.

Monitoring their physical health is an added concern, especially for those suffering from disabilities who are currently reliant upon assistance from staff.

### SUMMARY OF THE INVENTION

According to the invention there is provided a method and system for allowing people to interact with others, including artificial intelligence (AI) systems that function as companions. The AI systems may serve as communication interface for talking with third parties, e.g., hands-free, voice-prompted video calls with family members. It may also provide a monitoring platform for monitoring a person's mental and physical well-being, and may act as a companion by engaging the person in conversation.

Further, according to the invention there is provided a system for improving the emotional and physical health of a user, comprising a microphone for capturing sound, a speaker for uttering verbal responses, a camera, a memory encoded with machine-readable code, and a processor connected with the memory and configured by logic defined by the machine-readable code to identify one or more emotional or physiological states of a user based on image data received from the camera and voice data received from the microphone, and comparing these to previously captured image data and voice prints, obtained from one or more of third parties, and the user, using an artificial intelligence (AI) network to perform analytics, wherein corroboration of a user's emotional or physiological state is provided by correlations between emotional and physiological states identified from the voice data, and emotional and physiological states identified from the images data.

The AI network may use image data and voice data received from the user that have been corroborated against each other for correlations in the identified emotional or physiological states, to refine the captured image data and voice prints as learning data for the AI network. The voice data may be analyzed for one or more of intonation, modulation, voice patterns, volume, pitch, pauses, speed of speech, slurring, time between words, choice of words, and non-verbal utterances.

The image data may be analyzed for body language and for facial expressions, which include one or more of the configuration of the mouth, the creases formed around the mouth, creases along the forehead and around the eyes, the state of the eyes, and the dilation of the pupils, compared to a relaxed facial expression of the user.

The machine-readable code may define logic configured to generate verbal outputs via the speaker in response to emotional and physiological states identified from the captured voice data and image data, in order to capture additional verbal data and image data to further corroborate the identified emotional and physiological states. The machine-readable code may also include logic that takes the identified emotional or physiological state of the user to engage the user in conversation or adjust the environment of the user, wherein the environment includes one or more of lighting, background sound or music, and temperature, wherein engaging the user in conversation includes making suggestions or posing questions. The machine-readable code may be arranged to define logic to initiate communication with at least one of, administrative staff responsible for the user, a physician or medical facility associated with the user, an emergency response entity, or a family member or emergency contact associated with the user. The system may further comprise a database for maintaining user information, and contact details of people associated with a user, wherein the database may include the previously captured image data and voice prints. The database may also include sound files of non-verbal data associated with emergencies that define trigger events, and the machine-readable code includes logic for comparing non-verbal sounds received from the microphone to the non-verbal sound files to identify an emergency and define a trigger event.

The making of suggestions or posing of questions may include the option to connect the user by voice or video to a third party, and may include making a suggestion to a user of a third-party to connect to, or receiving information from the user about which third-party to connect to.

The system may further comprise a robot that includes the speaker and is connected to the processor to be responsive to the outputs of the processor, the robot being configured through outputs from the processor to empathize and provide support through movement and voice response. The robot may be configured to move closer to the user in order to provide additional emotional support, capture low-volume verbal inputs, or capture a closer image of the user.

Still further, according to the invention, there is provided a method of improving the emotional and physiological health of a user, comprising monitoring the user with sensors and responding to the user's needs based on verbal signals and images captured from the user via the sensors, wherein the verbal signals and images are compared in time to corroborate each other in order to identify and validate one or more emotional or physiological states of the user.

The method may further comprise verbally interacting with the user in response to verbal signals and images captured and based on voice prompts uttered to the robot by the user.

The method may include building up a physiological and emotional profile of the user based on the sensor data and interactions with the user.

The method may also comprise identifying and validating emotional or physiological emergencies and notifying at least one third party in the event of a validated emergency.

### BRIEF DESCRIPTION OF THE DRAWINGS

FIG. 1 is a depiction of one embodiment of a system of the invention;

FIG. 2 is a flow chart defining the logic of one embodiment of an anomaly detection algorithm implemented in an AI system;

FIG. 3 is a flow chart defining the logic of one embodiment of an anomaly detection and corroboration algorithm implemented in an AI system, and

FIG. 4 is a depiction of part of another embodiment of a system of the invention.

### DETAILED DESCRIPTION OF THE INVENTION

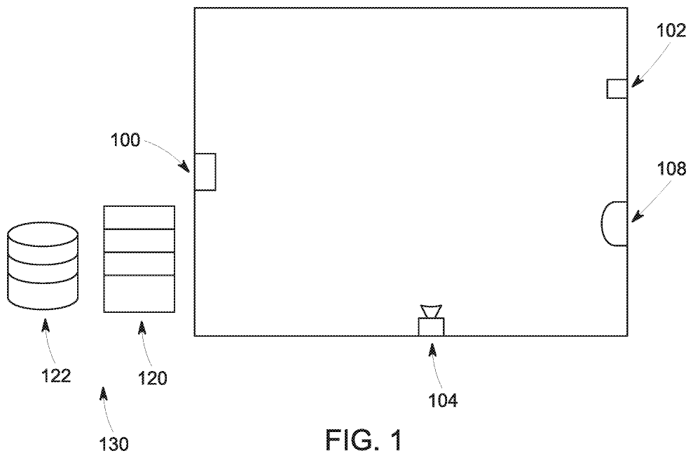

One implementation of an interactive communication platform of the invention is shown in FIG. 1. It includes a video camera 100 mounted on a wall in a user's apartment, a microphone 102 for capturing verbal and non-verbal sound information, and a speaker 104 for verbally addressing the user.

The camera 100, microphone 102, and speaker 104 are connected to a processor, which is not shown but is included in the housing for the speaker 104. The camera 100 and microphone 102 are communicatively connected to the processor by means of short-range wireless connections, in this case, Bluetooth.

The video camera 100 and microphone 102 are implemented to always be on or may be activated by movement or sound, respectively, in order to capture all activities of the user.

Both the camera 100 and microphone 102 can therefore pick up emergencies such as a fall by the user. The camera 100 will detect when a user drops to the ground, either slowly or suddenly, while the microphone 102 will pick up thuds or percussion sounds associated with a fall, even if the user is outside the viewing field of the camera 100. In many instances both devices could pick up anomalies or flagging events such as a person falling, allowing the information of one device, e.g., the camera 100 to be corroborated against that of the other device (in this case the microphone).

The system of the present embodiment also includes a memory (not shown) connected to the processor and configured with machine-readable code defining an algorithm for analyzing the data from the camera 100 and microphone 102 for anomalies compared to daily routines previously captured for the user, and stored in a section of the memory or a separate memory.

In this embodiment at least some of the processing is done locally but it will be appreciated that the processing could also be done remotely. In fact, the present embodiment does some of the processing remotely by including a radio transceiver (not shown), which in this embodiment is implemented as a WiFi connection to a server 120

The server 120 includes a database 122 for storing data from the video camera 100 and microphone 102, and flagging events identified by the local processor. In this embodiment the database 122 also captures sound files of non-verbal data associated with trigger events, and the system includes logic for comparing non-verbal sounds received from the microphone to the trigger events.

The database 122 includes previously captured image data and voice-prints obtained from the user to define part of the user's routines, habits, and characteristics. The database 122 also includes non-verbal sound files such as sounds associated with falling events of human beings.

Server 120 also includes a memory configured with machine readable code to define an artificial intelligence (AI) system (also referred to herein as an AI network), depicted by reference numeral 130. The AI system 130, inter alia, processes flagging events from one device (e.g. camera 100) and compares them with the other device (e.g., microphone 102) to identify corroboration for a corresponding time-frame.

As discussed above, the database 122 includes previously captured image data, voice-prints, and non-verbal sounds, which allows the AI system to compare information captured by the camera 100 and microphone 102 to the previously captured data to identify anomalies and possible problems.

Anomalies or flagging events may include deviations from a user's routine, e.g. not getting up half an hour after the usual waking-up time in the morning, or the microphone 102 picking up sobbing sounds. Certain flagging events may require a closer view of the user, and the AI system is configured to identify the location of the user and zoom in on the user to capture a closer view of the person or facial features.

In this embodiment the AI system also regularly zooms in on the user to analyze the psychological and physiological attributes of the user. This involves an analysis of both the speech-related parameters (as captured by the microphone 102) and the visual parameters (body posture and facial features captured by the camera 100).

In this embodiment, the voice signals are analyzed for intonation, modulation, voice patterns, volume, pitch, pauses, speed of speech, slurring, time between words, choice of words, and non-verbal utterances. The images are analyzed for facial expressions and body language. The facial expressions include the configuration of the mouth, the creases formed around the mouth, creases along the forehead and around the eyes, the state of the eyes, and the dilation of the pupils compared to a relaxed facial expression of the user.

The speaker 104 performs a dual function as social interactor and emergency support. It is integrated with the AI system to define a voice-bot for interacting with the user. It is configured to engage the user in conversation: in response to a trigger event (as discussed further below) and from time to time in the absence of a trigger event, such as at certain times of the day, e.g., when the camera 100 indicates that the user is about to get out of bed or go to bed.

An event (e.g. person getting out of bed) may be qualify as a trigger event or flagging event, e.g. when an anomaly is detected by the camera 100 or microphone 102. The flagging event may, depending on the nature of the event and its degree (e.g., if the anomaly exceeds a certain predefined threshold), qualify the event as one that requires third party intervention. In some cases the anomaly from one sensor may not exceed the threshold per se, but confirmation by another sensor that something is wrong, may elevate the anomaly to an event requiring one or more authorized persons to be notified (also referred to as flagging event, trigger event or emergency event). Thus, two devices may corroborate each other, or the devices may be configured to acquire additional information in the absence of sufficient information to warrant elevating the anomaly to an emergency event that warrants third party intervention.

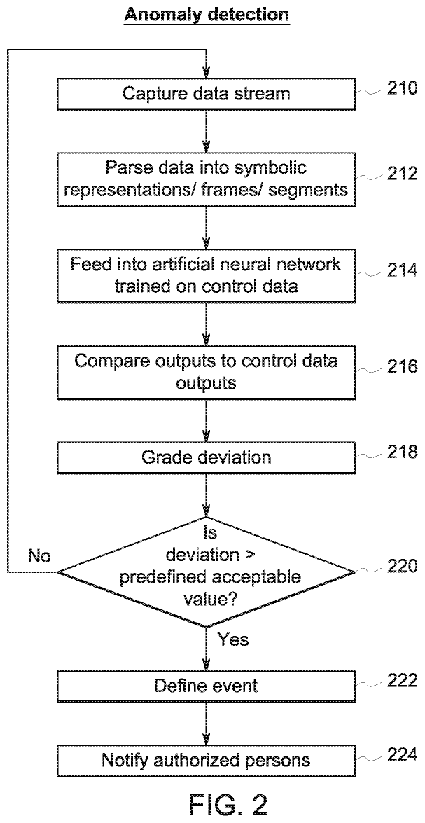

The implementation of such an analysis requires logic in the form of machine readable code defining an algorithm or implemented in an artificial intelligence (AI) system, which is stored on a local or remote memory (as discussed above), and which defines the logic used by a processor to perform the analysis and make assessments. One such embodiment of the logic based on grading the level of the anomaly, is shown in FIG. 2, which defines the analysis based on sensor data that is evaluated by an Artificial Intelligence (AI) system, in this case an artificial neural network. Data from a sensor is captured (step 210) and is parsed into segments (also referred to as symbolic representations or frames) (step 212). The symbolic representations are fed into an artificial neural network (step 214), which has been trained based on control data (e.g. similar previous events involving the same party or parties or similar third-party events). The outputs from the AI are compared to the control data (step 216) and the degree of deviation is graded in step 218 by assigning a grading number to the degree of deviation. In step 220 a determination is made whether the deviation exceeds a predefined threshold, in which case the anomaly is registered as an event (step 222) and one or more authorized persons is notified (step 224)

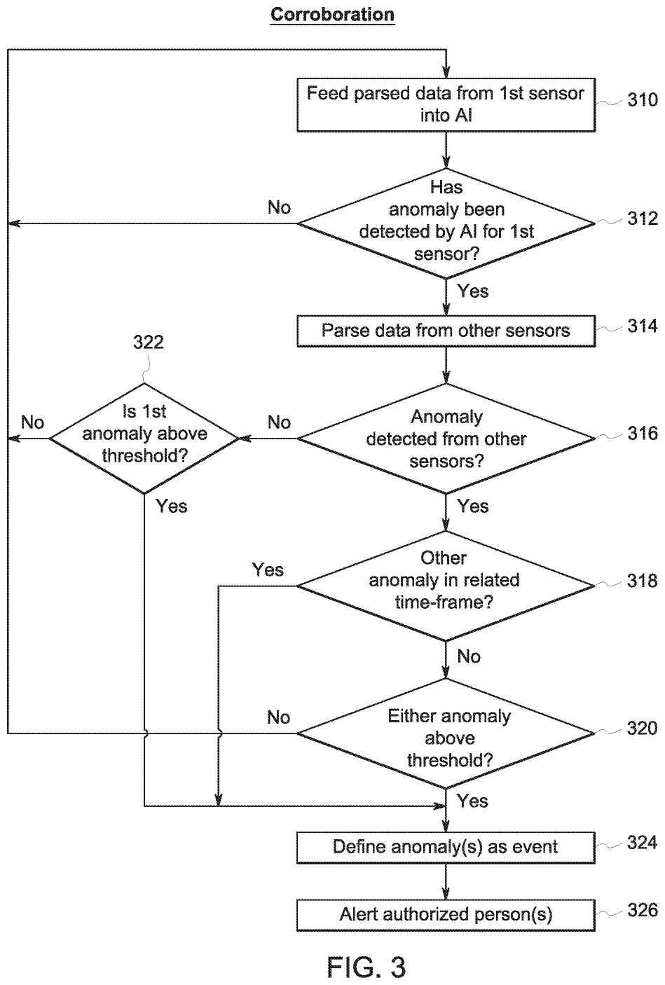

Another embodiment of the logic in making a determination, in this case, based on grading of an anomaly and/or corroboration between sensors is shown in FIG. 3.

Parsed data from a first sensor is fed into an AI system (step 310). Insofar as an anomaly is detected in the data (step 312), this is corroborated against data from at least one other sensor by parsing data from the other sensors that are involved in the particular implementation (step 314). In step 316 a decision is made whether any of the other sensor data shows up an anomaly, in which case it is compared on a time scale whether the second anomaly is in a related time frame (which could be the same time as the first sensor anomaly or be causally linked to activities flowing from the first sensor anomaly) (step 318). If the second sensor anomaly is above a certain threshold deviation (step 320) or, similarly, even if there is no other corroborating sensor data, if the anomaly from the first sensor data exceeds a threshold deviation (step 322), the anomaly captured from either of such devices triggers a flagging event (step 324), which alerts one or more authorized persons (step 326).

The camera, as discussed above, may zoom in on the user to assess body posture and facial features, and compare these to the image data in the database to assess physiological or psychological dispositions of the user.

In response to a verbal exclamation or non-verbal sound (e.g., one suggesting a falling event based on comparisons to previously captured sound files), the speaker 104 (shown in FIG. 1) may engage the user in conversation, e.g., asking: “Are you alright?” or “Is everything alright?”. By analyzing the speech patterns of the verbal response or the lack of a response, the AI system may elevate an event to a flagging event or emergency, initiating a call to one or more persons in the database 122.

Also, the AI system may use the voice signals and images captured from a specific user, which are associated with one or more corroborated emotional states, to refine the voice-prints and image data for the specific user. Thus, it becomes continuing teaching data for the AI system.

Similarly, the user may actively initiate a conversation or other interaction with the voice-bot by asking a question (e.g. to connect the user by video or audio link with a specified person or number) or by requesting an action.

Thus, the AI system, coupled with the speaker 104 and microphone 102, allows for both social interaction initiated by either the AI system or the user, as well as facilitates in-depth analysis of the user's vocal response in order to assess stress or other speech anomalies indicative of a psychological or physiological event. This may be supplemented with close-up image data of the user's body language and facial expression to allow the AI system to define or affirm a particular psychological or physiological event.

As the AI system assesses the user, the emotional state of the user may be used to refine the verbal engagement with the user. For example, upon determining that the user is depressed or sad it may ask empathizing questions. The system may also use verbal responses from the user or an analysis of the user's physiological or emotional state to adjust the environment of the user, e.g., increase the temperature, change the lighting, or play soothing music, or ask the user whether they wish to speak with a relative or other person. For this purpose, the database 122 may include contact details of administrative staff responsible for the user, a physician or medical facility associated with the user, an emergency response entity, or a family member or emergency contact associated with the user, etc.

The AI system can initiate interactions with the user on a regular basis as a virtual companion, and track the user's emotional state over time to define base levels and detect emotional extremes that would trigger an emergency or dangerous situation.

The AI system, in this embodiment is configured to automatically contact one or more emergency numbers, depending on the situation, or connect the user with a contact person.

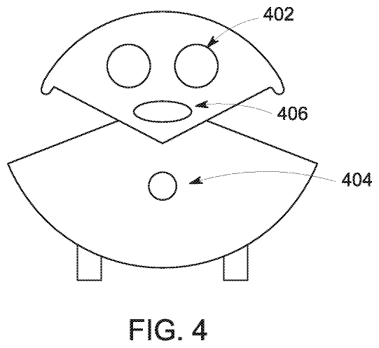

Another embodiment of the present system is shown in FIG. 4, wherein the AI system is implemented as a robot 400, which, in this embodiment is a mobile robot allowing it to approach the user for closer inspections, or to detect muffled or low-volume sounds, such as breathing or mumbling by the user.

This embodiment incorporates a camera 402, microphone 404, and speaker 406 in the robot 400. As in the FIG. 1 embodiment, the robot 400 may include both a processor for local processing of data captured by the camera 402 and microphone 404, as well as a transceiver (cell phone or internet based radio transceiver) to communicate with a remote server such as the server 120 discussed above with respect to FIG. 1.

The benefits of the present embodiment is its ability to take on a more life-like guise, making social interaction more natural for the user. The robot in this embodiment is configured through outputs from the processor to empathize and provide support through both movement and voice response.

While the present invention has been described with respect to specific embodiments, it will be appreciated that the invention could be implemented in different manners, with additional sensors and communication devices, and with differently configured processing of the data captured by the sensors, without departing from the scope of the invention.

What is claimed is:

1. A system for improving the emotional and physical health of a user, comprising a microphone for capturing sound,
a speaker for uttering verbal responses,
a camera,
a memory encoded with machine-readable code, and
a processor connected with the memory and configured by logic defined by the machine-readable code to identify one or more emotional or physiological states of a user based on image data received from the camera and voice data received from the microphone, and comparing these to previously captured image data and voice prints, obtained from one or more of third parties, and the user, using an artificial intelligence (AI) network to perform analytics, wherein corroboration of a user's emotional or physiological state is provided by correlations between emotional and physiological states identified from the voice data, and emotional and physiological states identified from the images data.

2. The system of claim 1, wherein the AI network uses image data and voice data received from the user that have been corroborated against each other for correlations in the identified emotional or physiological states, to refine the captured image data and voice prints as learning data for the AI network.

3. The system of claim 1, wherein the voice data is analyzed for one or more of intonation, modulation, voice patterns, volume, pitch, pauses, speed of speech, slurring, time between words, choice of words, and non-verbal utterances.

4. The system of claim 1, wherein the image data is analyzed for body language and for facial expressions, which include one or more of the configuration of the mouth, the creases formed around the mouth, creases along the forehead and around the eyes, the state of the eyes, and the dilation of the pupils, compared to a relaxed facial expression of the user.

5. The system of claim 1, wherein the machine-readable code defines logic configured to generate verbal outputs via the speaker in response to emotional and physiological states identified from the captured voice data and image data, in order to capture additional verbal data and image data to further corroborate the identified emotional and physiological states.

6. The system of claim 1, wherein the machine-readable code includes logic that takes the identified emotional or physiological state of the user to engage the user in conversation or adjust the environment of the user, wherein the environment includes one or more of lighting, background sound or music, and temperature.

7. The system of claim 6, wherein engaging the user in conversation includes making suggestions or posing questions.

8. The system of claim 7, wherein the machine-readable code is arranged to define logic to initiate communication with at least one of, administrative staff responsible for the user, a physician or medical facility associated with the user, an emergency response entity, or a family member or emergency contact associated with the user.

9. The system of claim 8, further comprising a database for maintaining user information, and contact details of people associated with a user.

10. The system of claim 9, wherein the database includes the previously captured image data and voice prints.

11. The system of claim 10, wherein the database includes sound files of non-verbal data associated with emergencies that define trigger events, and the machine-readable code includes logic for comparing non-verbal sounds received from the microphone to the non-verbal sound files to identify an emergency and define a trigger event.

12. The system of claim 11, wherein making suggestions or posing questions includes the option to connect the user by voice or video to a third party.

13. The system of claim 12, wherein the making of suggestions or posing of questions for purposes of connecting the user to a third party includes making a suggestion to a user of a third-party to connect to, or receiving information from the user about which third-party to connect to.

14. The system of claim 1, further comprising a robot that includes the speaker and is connected to the processor to be responsive to the outputs of the processor, the robot being configured through outputs from the processor to empathize and provide support through movement and voice response.

15. The system of claim 14, wherein the robot is configured to move closer to the user in order to provide additional emotional support, capture low-volume verbal inputs, or capture a closer image of the user.

16. A method of improving the emotional and physiological health of a user, comprising monitoring the user with sensors and responding to the user's needs based on verbal signals and images captured from the user via the sensors, wherein the verbal signals and images are compared in time to corroborate each other in order to identify and validate one or more emotional or physiological states of the user.

17. The method of claim 16, further comprising verbally interacting with the user in response to verbal signals and images captured and based on voice prompts uttered to the robot by the user.

18. The method of claim 17, comprising building up a physiological and emotional profile of the user based on the sensor data and interactions with the user.

19. The method of claim 15, comprising identifying and validating emotional or physiological emergencies and notifying at least one third party in the event of a validated emergency.
